(19) United States
(12) Patent Application Publication
(10) Pub. No.: US 2020/0333283 A1
(43) Pub. Date: Oct. 22, 2020

(54) LOW-SYMMETRY MESOPOROUS TITANIUM DIOXIDE ELECTRODE

(71) Applicant: KING SAUD UNIVERSITY, RIYADH (SA)

(72) Inventors: MOHAMED ALI GHANEM, RIYADH (SA); ABDULLAH MOHAMED AL-MAYOUF, RIYADH (SA); MABROOK SALEH ALI SALEH, RIYADH (SA)

(21) Appl. No.: 16/386,227

(22) Filed: Apr. 16, 2019

(51) Int. Cl. G01N 27/333; G01N 27/403; G01N 27/416; C01G 23/053

(52) U.S. Cl. CPC G01N 27/333; G01N 27/403; G01N 27/4166; C01P 2006/40; C01P 2006/12; C01P 2006/16; C01G 23/053

(57) ABSTRACT

The low-symmetry mesoporous titanium dioxide (lsm-TiO₂) for use in an electrode for direct sensing of hydroxide ions may be prepared by evaporation-induced self-assembly followed by two stages of annealing. An electrode made of a conductive substrate coated with the lsm-TiO₂ detects electrochemical oxidation of hydroxide ion solution by an oxidation peak for hydroxide ions at a lower potential than other metal electrodes. The oxidation process is irreversible under diffusion-control, the peak current linearly increases with hydroxide concentration within the concentration range from 1.0 to 50 mM, the detection limit may be 0.05 mM and the current sensitivity may be 0.181 mA/mM. The peak current is linearly dependent on alkaline solution pH and the dissociation constant of the hydroxide ion precursor. The electrode can be used in hydroxide sensing performed in nitrate, fluoride, chloride or sulfate supporting electrolyte, which makes the electrode a superior sensor for voltammetric hydroxide determination.

### BACKGROUND OF THE INVENTION

### 1. Field of the Invention

The present invention relates to electrodes, and particularly to a low-symmetry (short-range order) mesoporous titanium dioxide electrode for direct sensing of hydroxide ions.

### 2. Description of the Related Art

Hydroxide solutions are widely used in various industries involving manufacture or treatment of, for example, paper pulp, electroplating, alumina, soaps and wastewater. Therefore, methods and sensors for monitoring hydroxide ion concentration are in high demand, particularly for use at higher concentration ranges. Commonly used methods for measuring hydroxide ion concentration include an electrochemical sensor based on pH determination using selective glass electrodes and acid-base volumetric titrations. Indirect determination of hydroxide ion concentration is typically executed using such glass pH meter electrodes. However, these existing pH meter electrodes are reliable only at lower concentration ranges of hydroxide ions (pH ranging from 2 to 12); they become unstable and produce a significant error at higher hydroxide ion concentrations.

Direct determination of hydroxide concentrations in aqueous media based on voltammetric and amperometric approaches has been explored using metal electrodes of gold, platinum, and nickel microelectrodes or arrays under steady-state conditions. However, such efforts have several limitations that reduce the application of such electrodes for measuring hydroxide ion concentration. Thus, a low-symmetry mesoporous titanium dioxide electrode solving the aforementioned problems is described as follows.

### SUMMARY OF THE INVENTION

An electrode made of low-symmetry (short-range order) mesoporous titanium dioxide (lsm-TiO₂) may be used for direct detection of hydroxide ions. The lsm-TiO₂ of the electrode prepared as described herein may have about 200 m²/g surface area and semi-crystalline anatase structure. The lsm-TiO₂ catalyst was prepared by an evaporation-induced self-assembly (EISA) approach using a precursor/surfactant ratio of 1.5 wt. %, followed by a two-step annealing process. The lsm-TiO₂ electrode can accurately sense hydroxide in a variety of electrolytes without interference, which makes the present lsm-TiO₂ electrode suitable as an electroanalytical tool for the direct determination of hydroxide ion concentration.

These and other features of the present low-symmetry mesoporous titanium dioxide electrode will become readily apparent upon further review of the following specification and drawings.

### BRIEF DESCRIPTION OF THE DRAWINGS

FIG. 1A shows a schematic diagram of a three-electrode cell with lsm-TiO₂ electrode sensor used to test the electrical properties the low-symmetry mesoporous titanium dioxide electrode described herein.

FIG. 1B is a schematic diagram of the low-symmetry mesoporous titanium dioxide material disposed on a fluorine-doped tin oxide (FTO) substrate.

FIG. 2A is a comparison of wide-angle X-ray diffractograms for the present low-symmetry mesoporous titanium dioxide catalyst (lsm-TiO₂) (made with TBO/P123=1.5 wt. % ratio and two annealing steps, one at 350° C. for 3.0 h in N₂, then 400° C. for 4.0 h in air) vs. TiO₂ as above, but before annealing.

FIG. 2B is a comparison of small-angle X-ray diffractograms for the present low-symmetry mesoporous titanium dioxide catalyst (lsm-TiO₂) (made with TBO/P123 =1.5 wt. % ratio and two annealing steps, one at 350° C. for 3.0 h in N₂, then 400° C. for 4.0 h in air) vs. TiO₂ as above, but before annealing.

FIGS. 3A and 3B are scanning electron micrographs (SEMs) of low-symmetry mesoporous titanium dioxide catalyst at low magnification (FIG. 3A) and high magnification (FIG. 3B), respectively.

FIG. 3C is a transmission electron micrograph (TEM) of low-symmetry mesoporous titanium dioxide catalyst prepared as described herein.

FIG. 3D is an N₂ isotherm and corresponding plot of pore size distribution of low-symmetry mesoporous titanium dioxide catalyst prepared as described herein.

FIG. 4A are cyclic voltammetry measurements of a low-symmetry mesoporous titanium dioxide electrode prepared as described herein at 5 mV/s, recorded in 0.5 M KNO₃ solution and in the presence of 2.0 mM and 10 mM KOH.

FIG. 4B is the Tafel plot obtained from the CV plots of FIG. 4A.

FIG. 5A are linear sweep voltammograms (LSV) performed at 25 mV/s of a low-symmetry mesoporous titanium dioxide electrode prepared as described herein, recorded for different electrophoretic deposition times in 5.0 mM KOH with 0.5 M KNO₃.

FIG. 5B shows the corresponding peak currents achieved for sweeps as a function of different electrophoretic deposition times.

FIG. 6A are cyclic voltammograms taken at various scan rates of a low-symmetry mesoporous titanium dioxide electrode prepared as described herein recorded in 10 mM KOH in 0.5 M KNO₃.

FIG. 6B is a plot of measured and theoretical peak current (iₚₑₐₖ) vs square root of the scan rate for each CV scan rate in FIG. 6A.

FIG. 6C is a plot of peak potential vs logarithm of the scan rate for each CV scan rate in FIG. 6A.

FIG. 7A are linear sweep voltammograms (LSVs) taken at 25 mV/s for a low-symmetry mesoporous titanium dioxide electrode prepared as described herein (deposition time=2.0 min) recorded in different concentrations of KOH and 0.5 M KNO₃.

FIG. 7B is a plot of the peak current (iₚₑₐₖ) vs. the hydroxide ion concentration for each trace in FIG. 7A.

FIG. 8A is linear sweep voltammograms of a low-symmetry mesoporous titanium dioxide electrode prepared as described herein taken at 5 mV/s in solutions of 0.5 M KNO₃ (pH 6.55) with 1.0 mM of KCl, Na₂SO₄, NaF or KOH.

FIG. 8B is cyclic voltammograms (CVs) taken at 5 mV/s for 10 mM KOH in 0.5 M KNO₃, KCl or Na₂SO₄ as a supporting electrolyte.

FIG. 9A is linear sweep voltammograms (LSVs) taken at 5 mV/s for a low-symmetry mesoporous titanium dioxide electrode prepared as described herein in 10 mM of different base compounds in 0.5 M KNO₃ as a supporting electrolyte.

FIG. 9B is a plot of peak current as a function of the base dissociation constant for the LSVs of FIG. 9A.

FIG. 9C is a plot of the logarithm of the peak current of the LSVs of FIG. 9A as a function of the measured pH of the hydroxide ion solutions.

Similar reference characters denote corresponding features consistently throughout the attached drawings.

### DETAILED DESCRIPTION OF THE PREFERRED EMBODIMENTS

The low-symmetry mesoporous titanium dioxide (lsm-TiO₂) electrode may be used for direct detection of hydroxide ions. The lsm-TiO₂ in the electrode prepared as described herein may have about 200 m²/g surface area and a semi-crystalline anatase structure. The lsm-TiO₂ catalyst was prepared by an evaporation-induced self-assembly (EISA) approach using, e.g., a Ti precursor/surfactant ratio of 1.5 wt. %, and is followed by a two-step annealing process. The porosity, order, surface area, crystallinity and microstructure of the lsm-TiO₂ catalyst prepared in the following examples were characterized by X-ray diffraction (XRD), Brunauer-Emmett-Teller (BET) analysis, scanning electron microscopy (SEM) and transmission electron microscopy (TEM) techniques. The electrochemical behavior of hydroxide ions at the lsm-TiO₂ electrode prepared as described herein shows a characteristic oxidation wave at a potential of 0.85 V over that of a saturated calomel electrode (SCE), and the peak current is linearly dependent on the hydroxide ion concentration within the range 1.0 to 50 mM, with a detection limit and a current sensitivity of 0.05 mM and 0.181 mA/mM, respectively. Hydroxide ion sensing using the electrode described herein can be executed in a nitrate, fluoride, chloride, or sulfate supporting electrolyte, without interference. As such, the lsm-TiO₂ electrode described herein is particularly suitable as an electroanalytical tool for the direct determination of hydroxide ion concentration. The low-symmetry mesoporous titanium dioxide (lsm-TiO₂) electrode will be better understood by reference to the following examples.

### EXAMPLE 1

### Preparation of lsm-TiO₂

A non-ionic surfactant (Pluronic® P123, Mw=5800, EO₂₀PO₇₀EO₂₀, Sigma Aldrich) was used to form the mixed solution (gel), and Titanium n-butoxide (TBO, Ti(OBu)₄, 97%, Aldrich) was used as Ti precursor. Hydrochloric acid (HCl, 37 wt. %, AnalaR) and absolute ethanol (C₂H₆O, AnalaR) were all supplied by Shanghai Chemical Corp. Potassium hydroxide, sodium hydroxide, potassium chloride, potassium iodide and sodium sulfate were purchased from Sigma-Aldrich, and all chemicals were used as received without further purification. All solutions were prepared using distilled water (Milli-Q, Millipore, Inc.) with a resistivity of 18.2 MΩ-cm.

The low-symmetry mesoporous titanium dioxide (lsm-TiO₂) catalyst was synthesized by ligand-assisted evaporation-induced self-assembly (EISA) method using a Titanium n-butoxide (Ti(OBu)₄):Pluronic® P123 surfactant ratio of 1.5 wt. %, in the presence of acetylacetone (AcAc) as a coordination agent in an ethanolic solution, and followed by a two-step annealing process. In an exemplary synthesis, the P123 surfactant (0.50 g, 0.0862 mmol) was completely dissolved in 10.0 g (217 mmol) of absolute ethanol. A quantity of 1.5 g of TBO (titanium n-butoxide) was dissolved in AcAc solution at a TBO:AcAc ratio of 2:3 wt. %, and the TBO:AcAc solution was added to the surfactant solution and mixed by stirring for 30 min at room temperature. Subsequently, 1.5 g of concentrated HCl (36 wt. %) was added dropwise under vigorous stirring to the reaction mixture, followed by further stirring for 1.0 h. The resulting yellow-color homogeneous solution was decanted into Petri dishes to allow for evaporation of the solvents at room temperature for 10 min, and then heated at 40° C. for 48 h. The resulting light-yellow transparent membrane was scraped from the Petri dishes and pyrolyzed in a tubular furnace at 350° C. for 3.0 h under N₂, raised to temperature at a heating rate of 1.0° C./min, still under N₂. After pyrolysis, the color of the composite was grey, presumably due to incorporation of carbon remaining from evaporated surfactant. Finally, a white, low symmetry mesoporous TiO₂ (lsm-TiO₂) product was obtained by further annealing of the grey composite powder in open air at 400° C. for 4.0 h. The lsm-TiO₂ obtained was in the form of a powder.

The obtained lsm-TiO₂ corresponded to the Ti(OBu)₄ precursor weight of 1.5 g added during the synthesis process, according to the theoretical yield of the present synthesis process of around 23.4%. This theoretical yield is presumably due to the organic part of the titanium precursor being completely burned off during annealing. For example, the procedure performed as above resulted in about 0.33 g lsm-TiO₂, which is around 22% of the precursor weight, very close to the theoretical yield of 23.4%.

### EXAMPLE 2

### Characterization Methods and Measurements

Surface morphology characterization of the lsm-TiO₂ catalyst was performed using a high-resolution scanning electron microscope (SEM, Hitachi 54800, Japan) operated at 1.0 kV and 10 mA, and using a high-resolution transmission electron microscope (TEM, JEOL 2100F, Japan) operated at 200 kV and equipped with an energy dispersive X-ray (EDX) detector. The samples for TEM measurements were dispersed in ethanol solution and supported onto carbon film on a Cu grid. Small-angle X-ray (SAXS) measurements were performed using a small-angle scattering system (Nanostar U, Bruker, Germany) using Cu Kₐ radiation (40 kV, 35 mA). XRD patterns were recorded using a benchtop X-ray diffractometer (Rigaku Mini Flex 600) using Cu K_{α} radiation (40 KV, 15 mA). Nitrogen adsorption isotherms were measured at 77 K using a surface area analyser (NOVA 2200e). Before acquiring isotherms, samples were degassed in a vacuum at 180° C. for at least 6 h. The specific surface area was calculated by Brunauer-Emmett-Teller (BET) method using the adsorption data at a relative pressure)(P/P^{O})=0.05-0.25 and pore size distribution and pore volume were derived from the adsorption branch using the Barrett-Joyner-Halenda (BJH) model. The total pore volume (Vₜₒₜₐₗ) was estimated from the adsorbed amount at a relative pressure P/P^{O} of 0.992.

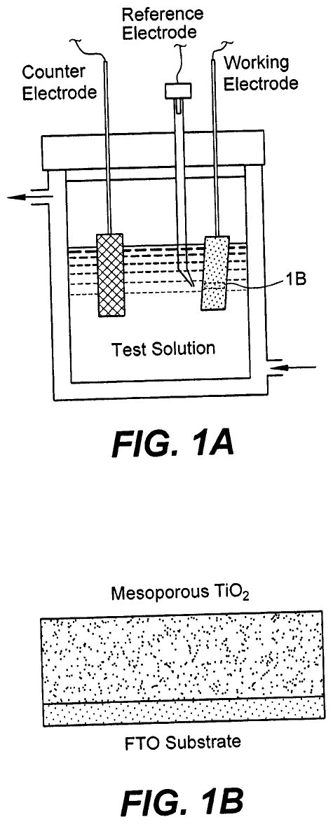

Electrochemical measurements were made using a potentiostat (BioLogic SAS model) in standard three-electrode system (see FIG. 1A), using the lsm-TiO₂ deposited on Fluorine-doped tin oxide (FTO) substrate (area=1.0 cmx1.0 cm) as a working electrode (see FIG. 1B), and a coiled Pt mesh (area=1.0 cm²) and saturated calomel electrode as a counter electrode and reference electrode, respectively. The supporting electrolyte was an aqueous solution of 0.5 M KNO₃ with different concentrations of KOH as a source for hydroxide ions, unless otherwise stated. To prepare working electrodes, the lsm-TiO₂ was deposited onto the FTO substrate by electrophoretic deposition. In a typical procedure, 15 mg of lsm-TiO₂ was dispersed in 1.0 ml of a solution made by dissolving 40 mg iodine (Alfa-Aesar) in 15 ml acetone. The lsm-TiO₂ in solution was mixed by the ultrasonic probe for 10 min to get a uniform dispersion of the material in a deposition solution. The lsm-TiO₂ particles were coated on the negative electrode by immersing the FTO substrate in parallel with an FTO anode in the deposition solution with approximately 1.0 cm distance between them, and then applying +10 V of bias between them for 6 min using the potentiostat. To produce catalyst films with different thicknesses, the electrophoretic deposition time was varied as 0.5, 1.0, 2.0, 4.0, 6.0, 8, 12 and 15 minutes. After coating the catalyst on the FTO substrate, the electrodes were rinsed with deionized water, dried in air and then annealed at 350° C. K for 30 min under a flow of N₂ gas to improve conductivity of the electrodes.

### EXAMPLE 3

### Structural characterization of lsm-TiO₂

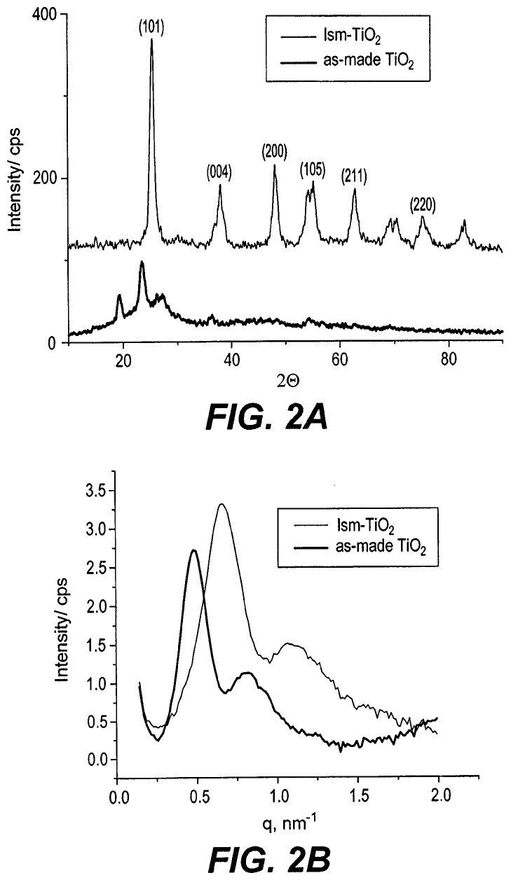

The structure of the exemplary lsm-TiO₂ catalyst, prepared as described above, was investigated by XRD. FIG. 2A shows wide-angle X-ray characterization of the lsm-TiO₂, as-made TiO₂ (i.e., before annealing) and in final form (i.e., after annealing). Weak and broad diffraction peaks evident in FIG. 2A are presumably due to the highly amorphous nature of the mesoporous TiO₂ deposit. After annealing, distinctive diffraction signals are evident, corresponding to the anatase phase of TiO₂ (see JCPDS, 21-1272) at 20 of 25.5, 37.8, 48.2, 54.2, 55.24, 62.9, 69.4, 70.6, 75.2 and 82.7. These distinct signals can be attributed to the (101), (004), (200), (105), (211), (204), (116), (220), (211) and (224) diffraction planes, respectively. The TiO₂ characteristic peaks were observed with no interference from other crystalline impurities in the XRD patterns of the lsm-TiO₂, suggesting pure crystalline anatase TiO₂ after annealing. However, the breadth of the diffraction peaks suggests an amorphous nature of the lsm-TiO₂ catalyst and a random arrangement of crystallites. The crystallite size of the lsm-TiO₂ catalyst, calculated according to Scherrer's equation, equals 14.18 nm, indicating formation of moderate crystalline TiO₂ walls.

FIG. 2B depicts low-angle X-ray signals for the lsm-TiO₂ catalyst before and after annealing in N₂ at 350° C., followed by air at 400° C. The as-made lsm-TiO₂ (before annealing) catalyst exhibits a well-resolved peak with a q value of 0.44 nm⁻¹, as well as a small and broad peak at 0.8 nm⁻¹, presumably due to its mesoporous structure.

After annealing, the first diffraction peak shifts from 0.44 nm⁻¹ to 0.67 nm⁻¹. This is presumably due to shrinkage of the TiO₂ framework and crystallization during removal of the template. A small shoulder around q=1.2 nm⁻¹ presumably arises from increased order of the mesoporous structure.

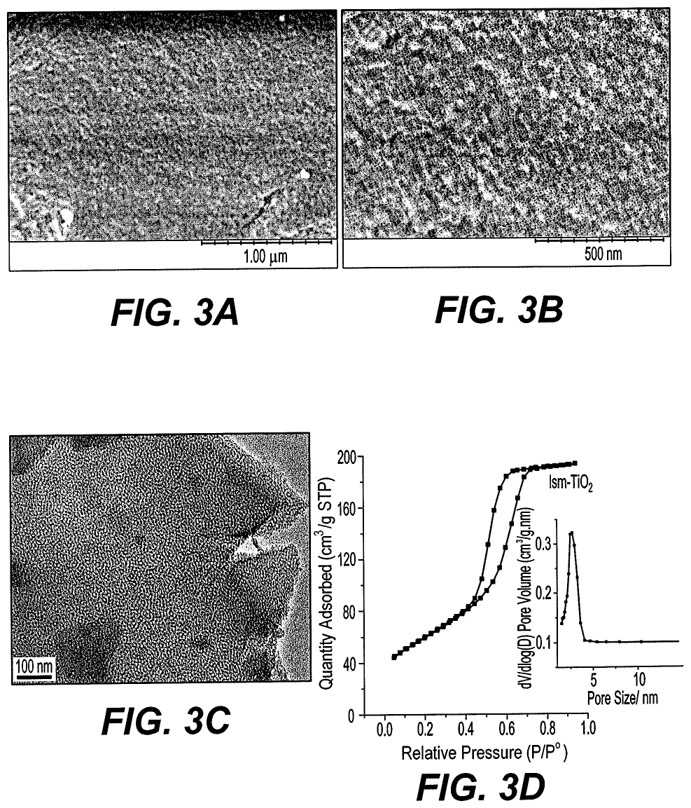

The surface morphology and nanostructure of the lsm-TiO₂ catalyst were characterised by SEM and TEM, respectively. FIGS. 3A, 3B, and 3C show SEM and TEM images of the lsm-TiO₂ catalyst after annealing in N₂ at 350° C. and then in air at 400° C. The low magnification SEM image of FIG. 3A shows uniform surface morphology of lsm-TiO₂ catalyst over a micrometer scale, while the high magnification SEM image in FIG. 3B visualizes spherical mesopores distributed over a nanometer scale that are well packed at short-range order. The transmission electron microscopy (TEM) image of the lsm-TiO₂ catalysts presented in FIG. 3C shows low-symmetry (short-range order) mesoporous structure of the catalyst and the pores with worm-like morphology extended over micrometers.

Mesoporosity of the exemplary lsm-TiO₂ catalyst was determined through N₂-physisorption measurements. FIG. 3D shows the N₂ adsorption-desorption isotherms and the corresponding pore size distributions of the lsm-TiO₂ sample (inset) after annealing in N₂ at 350° C. and air at 400° C. The adsorption and desorption isotherms are consistent with a typical IV isotherm with H₁-type hysteresis loops, which are representative of mesoporous materials according to the IUPAC classification. The isotherm of the lsm-TiO₂ catalyst exhibits well-defined H₁ hysteresis loops and a distinct capillary condensation step at P/P° of 0.4-0.7, which indicates a uniform and narrow mesopore size distribution. The corresponding pore size distribution curves were calculated according to Barrett-Joyner-Halenda (BJH) theory using the adsorption branch of the hysteresis loops, as shown in the inset of FIG. 3D. The pore size distribution of the exemplary lsm-TiO₂ catalyst is around 3.0 nm, which is consistent with the SEM characterization discussed above.

The textural properties of the lsm-TiO₂ catalyst, such as the specific surface area, total pore volume and pore size, are summarized in Table 1. The lms-TiO₂ catalyst has a larger specific surface area and pore volume than bare TiO₂. The specific surface area of lsm-TiO₂ reaches 200 m²/g, which is consistent with ultrathin amorphous walls, extended mesostructure and rough surfaces.

TABLE 1
Textural properties of lsm-TiO₂

| | d- | surface | Pore | Wall | Pore |
|---|---|---|---|---|---|
| | spacing ± | area ± | size ± | thickness ± | volume ± |
| | 0.5 | 3.0 | 0.3 | 0.5 | 0.05 |
| Catalyst | (nm) | (m²/g⁼) | (nm) | (nm) | (cm³/g) |
| lsm-TiO₂ | 9.30 | 200 | 2.70 | 6.60 | 0.290 |

### EXAMPLE 4

### Electrochemical Oxidation of Hydroxide Ion at the lsm-TiO₂ Electrode

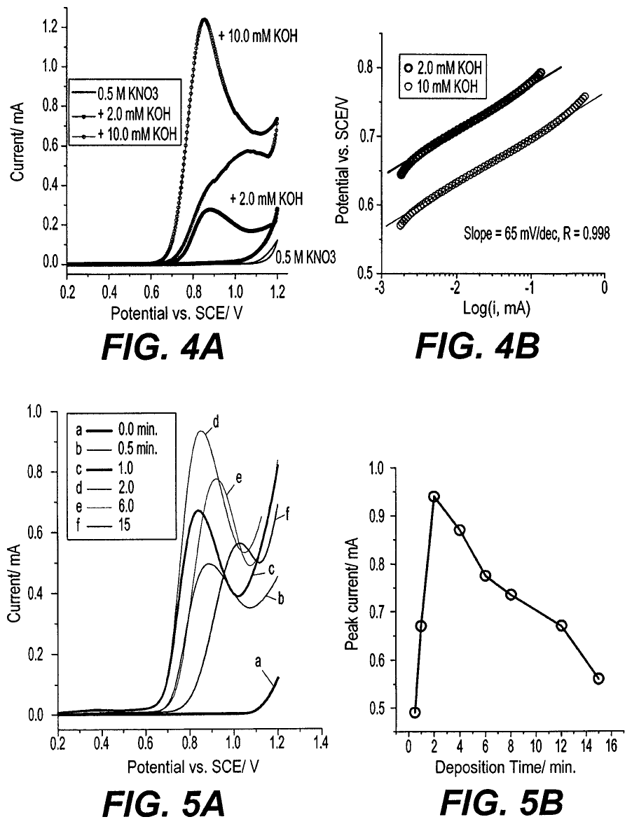

FIG. 4A shows the cyclic voltammogram (CV) for the exemplary lsm-TiO₂ electrode in 0.5 KNO₃ (black line) as a supporting electrolyte alone and in the presence of 2.0 mM and 10 mM KOH, taken at a scan rate of 5 mV/s. In just supporting electrolyte of 0.5 M KNO₃ (0 mM KOH) the CV clearly shows no current recorded in the potential region from 0.0 to 1.0 V with respect to the SCE. With the addition of 2.0 mM KOH to the supporting electrolyte, a well-resolved oxidation peak appears at a peak potential of 0.885 V with respect to the SCE and peak current of 0.27 mA. The oxidation peak is irreversible, as evinced by the absence of a reduction peak in the reverse scan up to −0.4 V with respect to the SCE. The peak current is significantly enhanced by increasing the hydroxide ion concentration to 10 mM, which confirms this peak is due to hydroxide ion oxidation at the surface of the lsm-TiO₂ electrode according to the equation (1).

OH⁻e⁻→¼O₂+½H₂O (1)

The presence of the OH⁻ oxidation peak and absence of a reduction peak is consistent with the classical one-electron EC reaction scheme established by Krasilshchikov (see Zh. Fiz. Khim. (1963) 37 531) and Damjanovic (“Oxygen Evolution at Platinum Electrodes in Alkaline Solutions”, J. Electrochem. Soc. (1987) 134, 113-117) for one electron hydroxide ion oxidation and oxygen evolution in alkaline solution at a platinum electrode. The EC reaction mechanism is a chemical step of oxygen evolution following the adsorption of an OW ion and electron transfer at the electrode. The Tafel slopes measured for low and high OW concentrations, shown in FIG. 4B, equal 65 mV/dec each, which is very consistent with the value of 60 mV/dec obtained for oxygen evolution in alkaline solution at a platinum electrode through the EC reaction mechanism reported in Damjanovic, supra. Beyond this hydroxide ion oxidation peak observed in FIG. 4A, at a potential more than 1.1 V with respect to the SCE, the current considerably increases, which presumably originates from direct water oxidation and evolution of oxygen bubbles following the reaction in equation (2).

H₂O−2e⁻→½O₂+2H⁺ (2)

No overlap exists between the oxygen evolution and the hydroxide ion oxidation peak, as the oxygen evolution occurs at potential more than 1.10 V with respect to the SCE. Such a hydroxide ion oxidation peak has not been observed before within this overpotential range using electrodes of any other materials. Previously studied gold, platinum, or boron-doped diamond electrodes show a similar wave for hydroxide ion oxidation as occurs using the present lsm-TiO₂ electrodes, but such a wave occurs at a much higher potential of 1.3 V with respect to the SCE, and having a few microamperes steady-state oxidation current. Moreover, no oxide peak is observed at the surface of the lsm-TiO₂ electrodes in the absence of hydroxide ions, whereas a metal oxide layer is readily formed at the electrode surface of the previously studied metal electrodes at a more positive potential that strongly overlaps with hydroxide ion oxidation.

### EXAMPLE 5

### Signal Optimization Studies

Because the lsm-TiO₂ film is highly porous, the thickness of the deposited film on the FTO substrate was varied for optimization. FIG. 5A shows linear sweep voltammagrams (LSV) taken at 25 mV/s in 5.0 mM KOH and 0.5 KNO₃ solution for lsm-TiO₂ films deposited at various electrophoretic deposition times. The plot of the electrophoretic deposition time versus the OW oxidation peak current is shown in FIG. 5B, which exhibits maximum peak current obtained for electrodes formed using a 2-minute deposition time. With increasing deposition time, the measured peak current initially gradually increases, reaching a maximum current density of 0.93 mA for the electrode formed using 2 min deposition. This presumably arises from enhancement of the electrochemically active surface area of the lsm-TiO₂ electrode with increasing film thickness. Further increase in the deposition time beyond 2 minutes results in a decrease in the peak current, again, presumably due to limited ion diffusion inside the mesoporous layer and resulting decreased conductivity of the lsm-TiO₂ electrode with film thickness.

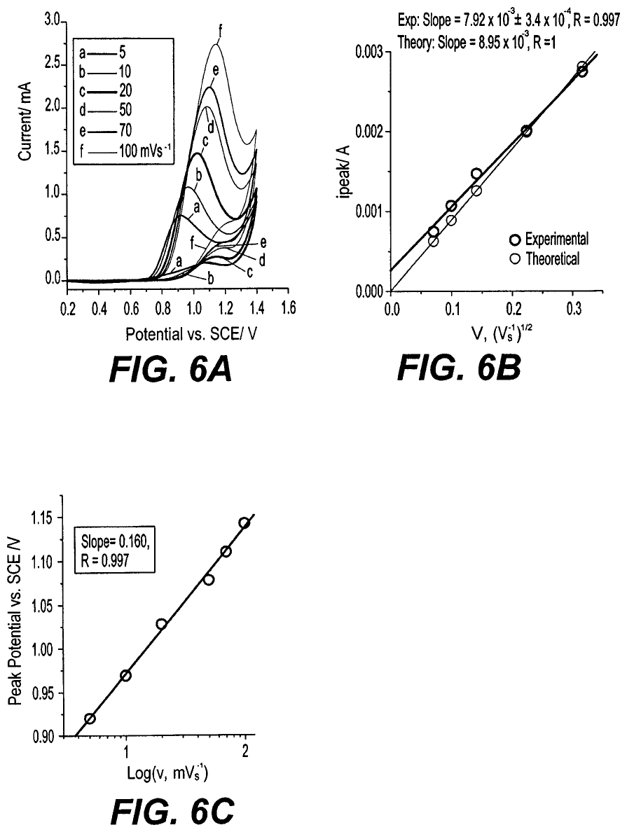

To confirm whether this optimal peak current measured is due to oxidation of hydroxide ion or surface oxidation of the lsm-TiO₂ electrode, CVs were measured using different scan rates, resulting in the plots shown in FIG. 6A. The relationship between peak current and the square root of the scan rate is shown in FIG. 6B. The peak current increases linearly with the square root of the scan rate within the scan range of 5 to 100 mV/s. This behavior is consistent with the current peak being due to OW oxidation rather than surface oxidation of the lsm-TiO₂ electrode surface, and the process being under diffusion control. The linear fitting analysis of the experimental data yielded a slope of 7.92×10⁻³ with R=0.997, as shown in FIG. 6B. Moreover, the peak potential is linearly shifted to more positive potentials by a value of 160 mV vs. the logarithm scan rate, as shown in FIG. 6C, confirming the irreversibility of the hydroxide ion oxidation at the lsm-TiO₂ electrode. The charge transfer coefficient (α) can be estimated as about 0.2 using the slope of the Eₚₑₐₖ vs. log v relationship, which is theoretically 30/α mV. Applying the value of α=0.2 to the Randles-Sevcik equation for an irreversible and diffusion-controlled process using the number of electron (n=1) and OH⁻ diffusion coefficient (D=4.5×10⁻⁵ cm²/s) results in a theoretical slope value of 8.95×10⁻³ for the relation of peak current with the square root of the scan rate, also as shown in FIG. 6B. The experimental and theoretical slopes shown in FIG. 6B are in good agreement, indicating that the hydroxide ion oxidation at the lsm-TiO₂ electrode is well-described by the Randles-Sevcik equation for an irreversible and diffusion-controlled process.

Therefore, it is likely that the oxidation peak occurring at the lsm-TiO₂ electrode is due to hydroxide ion oxidation at the lsm-TiO₂ electrode surface, which occurs at about 450 mV lower potential than at previously studied metal electrodes, and well before the onset of the oxygen evolution reaction.

### EXAMPLE 6

### Effect of Hydroxide Ion Concentration

The hydroxide ion oxidation at the lsm-TiO₂ electrode can be executed without any particular electrode or cell geometry arrangement. Moreover, the oxidation peak is well resolved and may occur at 250 mV lower potential than does the oxygen evolution reaction. Such peak characteristics make the lsm-TiO₂ electrode a good candidate as an analytical tool for direct determination of the hydroxide ion concentration in unbuffered solutions.

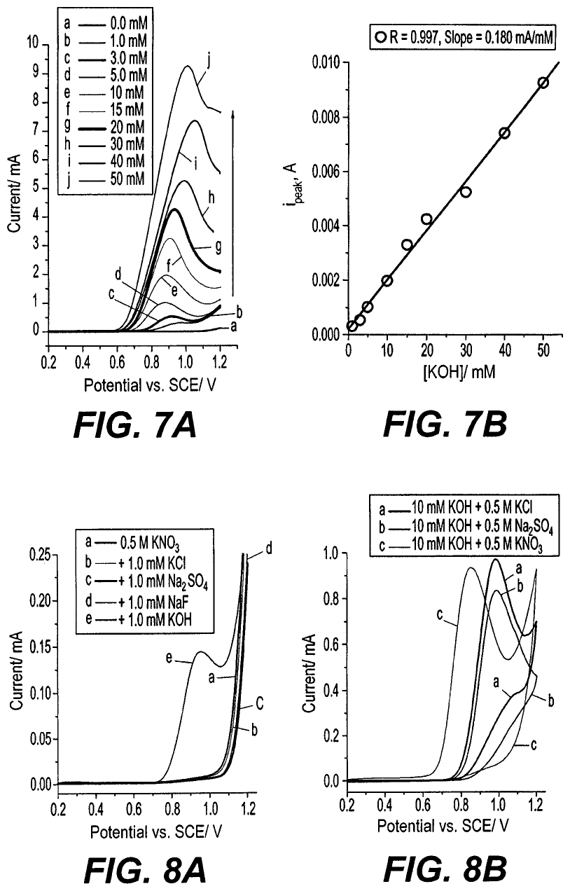

In order to obtain the relationship between the hydroxide ion concentration and the peak current, FIG. 7A shows LSVs performed at a rate of 25 mV/s in different concentrations of KOH solution using the lsm-TiO₂ electrode fabricated as above with a deposition time of 4 min. The peak current (iₚₑₐₖ) occurred at an overpotential of around 0.90 V with respect to the SCE. Plotting iₚₑₐₖ as a function of hydroxide ion concentration over a range of 1.0 mM to 50 mM yielded a well-fit linear relationship having a slope (iₚₑₐₖ/[OH⁻]) of 0.180 mA/mM, with R=0.998. Table 2 reports a comparison of hydroxide ion oxidation electroanalytical parameters obtained with the lsm-TiO₂ as described herein and known metal electrodes published in the literature. The current sensitivity value of 0.180 mA/mM obtained at the present lsm-TiO₂ electrode for sensing hydroxide ion oxidation is significantly higher than the standing highest value of 0.06 and 0.004 mA/mM obtained for conventional and ultra-microelectrode gold electrodes, respectively. The obtained (iₚₑₐₖ/[OH⁻]) slope is close to the theoretical value of 0.145 mA/mM calculated using the Randles-Sevcik equation for an irreversible and diffusion-controlled process using the number of electrons n=1, charge transfer coefficient α=0.2, OH⁻ diffusion coefficient D=4.5×10⁻⁵ cm²/s and scan rate of 0.025 V/s. Interestingly, the hydroxide ion detection extends over a wide range of concentrations up to at least 50.0 mM, with a concentration detection limit of 0.05 mM based on the 3σ-value. However, when the OW concentration increased above 50.0 mM, the peak current begins to overlap with current due to the oxygen evolution reaction, and it becomes difficult to distinguish and directly detect the hydroxide oxidation current. However, the higher hydroxide ion concentration above 50 mM can be determined using a dilution factor.

TABLE 2
Hydroxide ion oxidation electroanalytical parameters
obtained using lsm-TiO₂ vs. existing metal electrodes

| | Peak | [OH⁻] | Current | | |
|---|---|---|---|---|---|
| Electrode/ | potential/ | range, | sensitivity, | Detection | |
| diameter | electrolyte | mM | mA/mM | limit | |
| Gold/2.0 mm | 1.3 with respect | 2.0 to10 | 0.06 | — | |
| | to SCE/0.5 | | | | |
| | LiClO₄ | | | | |
| Gold ultra- | | | | | |
| microelectrode | | | | | |
| 170 array/10 μm | 1.4 V vs. | 0.05 to | 0.0012 | 20 | μM |
| 1550 array/5 μm | Ag/AgCl/3M | 1.0 | 0.004 | 10 | μM |
| | KCl | | | | |
| Diamond/3.5 mm | 1.25 V vs. | 0.5-10 | 0.015 | — | |
| | Ag/AgCl/0.1M | | | | |
| | NaClO₄ | | | | |
| lsm-TiO2 | 0.90 V with | 1.0-50 | 0.181 | 0.05 | mM |
| electrode/area | respect to SCE/ | | | | |
| 1.0 cm² | 0.5 KNO₃ | | | | |

### EXAMPLE 7

### Effect of Anion Interference and Hydroxide Ion Precursor

The lsm-TiO₂ electrode is very selective for hydroxide ion oxidation and is inactive for other anions such as Cl⁻, F⁻ or (SO₄)²⁻, as shown in FIG. 8A. LSVs taken using the lsm-TiO₂ electrode in 1.0 mM of Cl⁻, F⁻ or SO₄²⁻ anions and 0.5 M KNO₃ supporting electrolyte exhibit no oxidation peaks, and only the oxygen evolution reaction current is observed at an onset potential of around 1.1 V with respect to the SCE. To further verify the inactivity of lsm-TiO₂ electrode for the oxidation of Cl⁻ and SO₄²⁻ anions, oxidation of 10 mM KOH at the lsm-TiO₂ electrode was tested in the presence of 0.5 M KCl or Na₂SO₄ as supporting electrolytes, as shown in FIG. 8B. In case of Cl⁻ and SO₄²⁻ anion solutions, the [OH⁻] oxidation peak current (iₚₑₐₖ) is very close to the value obtained for NO₃⁻ electrolyte, while the peak potentials (Eₚₑₐₖ) occur 120 mV more positive than the value obtained for NO₃⁻ electrolyte. This may be due to the extent of anion adsorption strength at lsm-TiO₂ electrode decreasing in the order of SO₄²⁻>Cl⁻>NO₃⁻, corresponding to shifts in the onset of oxygen evolution to more positive potentials, respectively.

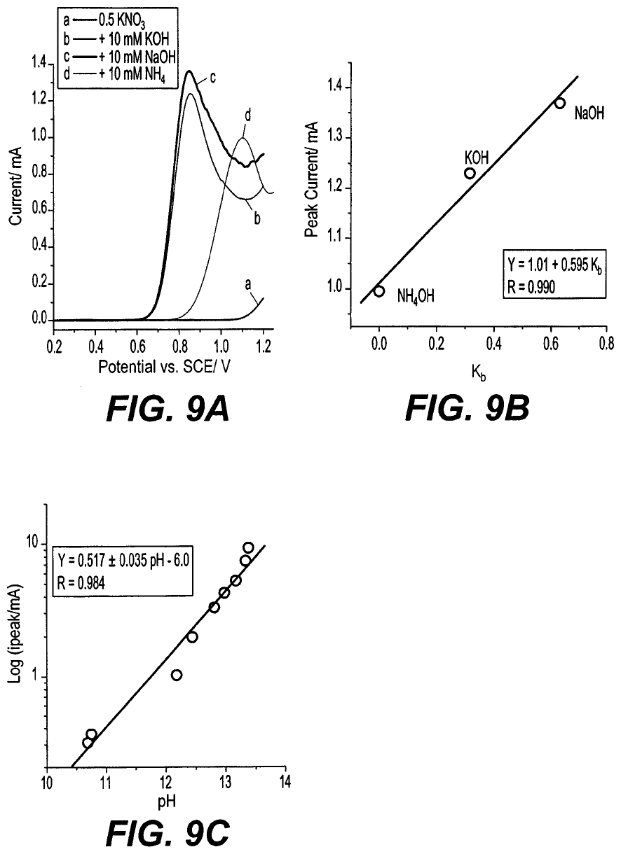

To examine the effect of the hydroxide ion precursor on the oxidation peak at the lsm-TiO₂ electrode, LSVs were taken using the lsm-TiO₂ electrode in 10 mM different base solutions in 0.5 M KNO₃ electrolyte (see FIG. 9A). For a same base concentration, the [OH⁻] peak current decreased in the order of NaOH>KOH>NH₄OH, which likely relates to base dissociation constants for each hydroxide ion precursor. Supporting this trend, the base dissociation constant and peak current follow an apparent linear relationship, as shown in FIG. 9B. The dissociation constants of NaOH and KOH (strong base) are much higher than NH₄OH (weak base). Consequently, the amount of hydroxide ions available for oxidation at the lsm-TiO₂ electrode in case of NH₄OH would be expected to be much smaller than in the cases of NaOH and KOH solutions. This further confirms the hypothesis of the peak current arising from hydroxide ion oxidation. Moreover, the peak current in case NaOH and KOH solution occurs at much lower potential (0.85 V) than in case of the NH₄OH solution (1.10 V). When log(iₚₑₐₖ/mA) is plotted against the measured pH of the [OH⁻] solution as shown in FIG. 9C, a linear relationship was obtained with a slope of 0.517 demonstrating the possibility of using the lsm-TiO₂ electrode for measuring the pH of alkaline solutions.

In summary, low symmetry (short-range order) mesoporous TiO₂ electrodes having a specific surface area of 200 m²/g were prepared by evaporation-induced self-assembly (EISA). The electrochemical oxidation of hydroxide ion solution in lsm-TiO₂ electrodes exhibited a novel and well-defined oxidation peak for hydroxide ions at a potential of 0.85 V with respect to the SCE, which is a significantly lower potential than known metal electrodes. The oxidation process appears to be irreversible and under diffusion control. The peak current versus the square root of voltage or the OW concentration is consistent with the Randles-Sevcik equation describing irreversible and diffusion-controlled process. The measured peak current linearly increases with [OH⁻] within a concentration range of at least 1.0 to 50 mM, with a detection limit of 0.05 mM based on 3σ-calculation and current sensitivity of 0.181 mA/mM. Moreover, the peak current depended linearly on alkaline solution pH and the dissociation constant of the hydroxide ion precursor. Hydroxide sensing was demonstrated in nitrate, fluoride, chloride or sulfate supporting electrolytes without particular requirements on cell geometry or electrode special arrangements, which makes the lsm-TiO₂ electrodes fabricated herein superior for sensing hydroxide concentration over existing voltammetric hydroxide determination methods and electrodes.

It is to be understood that the low-symmetry mesoporous titanium dioxide electrode is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1-6. (canceled)

7. A method of making an electrocatalyst selective for hydroxide ion (OH—), comprising the steps of:
(a) combining a surfactant with a titanium oxide precursor dissolved in a nonpolar solvent with a coordination agent to form a reaction solution;
(b) mixing the reaction solution for a first period of time;
(c) adding an acid to the reaction solution;
(d) mixing the reaction solution for a second period of time;
(e) evaporating the reaction solution to obtain a dried product;
(f) annealing the dried product under an inert gas at a first temperature to obtain a pyrolyzed product; and
(g) annealing the pyrolyzed product at a second temperature to obtain the electrocatalyst.

8. The method of making an electrocatalyst according to claim 7, wherein the coordination agent is acetylacetone.

9. The method of making an electrocatalyst according to claim 7, wherein the titanium oxide precursor is titanium n-butoxide (Ti(OBu)₄) and the reaction solution has a weight ratio of (Ti(OBu)₄): surfactant of 1.5 wt. %.

10. The method of making an electrocatalyst according to claim 7, wherein the inert gas is N2 and the first temperature is at least 350° C.

11. The method of making an electrocatalyst according to claim 7, wherein the second annealing step (g) is performed in air and the second temperature is at least 400° C.

12. The method of making an electrocatalyst according to claim 7, further comprising the step of coating a fluorine-doped tin oxide substrate with the electrocatalyst obtained in step (g) in order to obtain an electrode selective for hydroxide ion (OH—) concentration.

13. The method of making an electrocatalyst according to claim 7, wherein said step of adding an acid to the reaction solution comprises adding concentrated hydrochloric acid dropwise to the reaction solution and said step of mixing the reaction solution for a second period of time comprises stirring the reaction solution for one hour.

14. A low-symmetry mesoporous titanium dioxide electrode, comprising an electrode made by deposing an electrocatalyst selective for hydroxide ion concentration on a conductive substrate by electrophoretic deposition, the electrocatalyst being made by the process of:
(a) combining a non-ionic surfactant with a titanium oxide precursor dissolved in a nonpolar solvent with a coordination agent to form a reaction solution;
(b) mixing the reaction solution for a first period of time;
(c) adding an acid to the reaction solution;
(d) mixing the reaction solution for a second period of time;
(e) evaporating the reaction solution to obtain a dried product;
(f) annealing the dried product under nitrogen at 350° C. for three hours to obtain a pyrolyzed product; and
(g) annealing the pyrolyzed product at 400° C. for three hours to obtain the electrocatalyst, wherein the electrocatalyst has:
i) a pore size between 2.40 nm and 3.00 nm;
ii) a surface area between 197 and 203 m²/g; and
iii) a wall thickness between 6.1 mu and 7.1 nm,
wherein the electrode exhibits an irreversible oxidation peak upon cyclic voltammetry in the presence of hydroxide ion (OH⁻) at a voltage between 0.0 and 1.0 volts.

15. The low-symmetry mesoporous titanium dioxide electrode according to claim 14, wherein said conductive substrate comprises fluorine-doped tin oxide.

16. The low-symmetry mesoporous titanium dioxide electrode according to claim 14, wherein the coordination agent is acetylacetone.

17. The low-symmetry mesoporous titanium dioxide electrode according to claim 14, wherein the titanium oxide precursor is titanium n-butoxide (Ti(OBu)₄) and the reaction solution has a weight ratio of Ti(OBu)₄: surfactant of 1.5 wt. %.

18-20. (canceled)
